(19) United States
(12) Patent Application Publication
(10) Pub. No.: US 2009/0054546 A1
(43) Pub. Date: Feb. 26, 2009

(54) RESINS FOR UNIVERSAL USE

(75) Inventors: Patrick Glockner, Haltern am See (DE); Evelyn Albrecht, Recklinghausen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/159,673

(22) PCT Filed: Nov. 3, 2006
(86) PCT No.: PCT/EP2006/068062

§ 371 Date: Jun. 30, 2008

(30) Foreign Application Priority Data
Jan. 3, 2006 (DE) 10 2006 00 644.5

(51) Int. Cl. C08L 75/06; C08G 18/72

(52) U.S. Cl. 522/174; 528/59; 528/61; 524/590; 525/452; 525/123

(57) ABSTRACT

The present invention relates to universally useful resins based on specific polyethers and on ketone, ketone/aldehyde or urea/aldehyde resins and also their hydrogenated derivatives, to a process for preparing them, and to their use as a main, base or addition component in aqueous, solvent-containing or solvent-free coating materials, ballpoint pen pastes, inks, including printing inks, polishes, glazes, pigment pastes, filling compounds, cosmetics articles, sealants or insulants and also adhesives, and for coloring plastics.

The present invention relates to universally useful resins based on specific polyethers and on ketone, ketone/aldehyde or urea/aldehyde resins and also their hydrogenated derivatives, to a process for preparing them, and to their use as a main, base or addition component in aqueous, solvent-containing or solvent-free coating materials, ballpoint pen pastes, inks, including printing inks, polishes, glazes, pigment pastes, filling compounds, cosmetics articles, sealants or insulants and also adhesives, and for coloring plastics.

Ketone-formaldehyde resins are already well established. Preparation processes have for example been described in DE 33 24 287, U.S. Pat. No. 2,540,885, U.S. Pat. No. 2,540,886, DE-C 11 55 909, DL-C 12 433, DE-C 13 00 256, and DE-C 12 56 898. These resins have long been hydrogenated (DE 826 974, DE 8 70 022, DE 32 41 735, JP 11012338, U.S. Pat. No. 6,222,009). Urea-aldehyde resins are described for example in DE 27 57 220, DE-A 27 57 176, and EP 0 271 776.

On account of their high melting points/ranges such resins are normally used in coating materials as additive hard resins, for example, to enhance certain properties such as rate of initial drying, gloss, hardness or scratch resistance. Because of their relatively low molecular weight, typical ketone-aldehyde resins, in particular, possess low melt viscosity and solution viscosity.

The brittleness inherent in these products as a concomitant to the combination of high melting point/range and relatively low molecular weight, however, prevents the use of the resins in, for example, coating materials in substantial amounts. Moreover, adhesion properties of coating materials may be impaired by addition of substantial amounts of unmodified ketone, ketone/aldehyde or urea/aldehyde resins.

Important factors for universal application are first a universal compatibility with other binders—such as with the significant long-oil alkyd resins, vegetable oils, hydrocarbon resins, acrylate resins, and polyamides—and secondly a universal solubility in organic solvents, such as in the white spirits and pure aliphatics that are frequently employed on environmental and toxicological grounds. Binders of this kind which can be used in pigment preparations and enjoy universal compatibility and solubility in organic solvents are described for example in DE 44 04 809 and in EP 1486520.

In addition, however, universal application requires that the systems be stably transferable into water.

It was an object of the invention to modify ketone resins, ketone/aldehyde resins, urea/aldehyde resins and/or their hydrogenated derivatives in such a way that they differ from the prior art, through the use of innovative compounds, and to develop a process for preparing them. The resins ought to be stable to hydrolysis and ought in particular to have less brittleness than the prior-art resins, though without impairment to properties such as gloss, hardness or scratch resistance. Moreover, the resins ought to be soluble in organic solvents and additionally ought to be soluble or dispersible, or miscible, in water.

The object on which the invention is based is surprisingly achieved in accordance with the claims of the patent, by using hydroxyl-containing ketone resins, ketone/aldehyde resins, urea/aldehyde resins and/or their hydrogenated derivatives with (poly)isocyanates and specific polyethers.

The resins are stable to hydrolysis and possess lower brittleness than the precursor resins, with gloss, hardness, and scratch resistance being retained. It was surprising that aqueous systems containing the resins of the invention have a low foam-forming tendency and a low viscosity.

The present invention provides universally useful resins, and also a process for preparing them, obtainable by sole reaction or proportional reaction of
A) hydroxyl-containing ketone resins, ketone/aldehyde resins, urea/aldehyde resins and/or hydrogenated derivatives thereof and
B) at least one aromatic, aliphatic and/or cycloaliphatic diisocyanate or polyisocyanate and
C) at least one specific polyether having at least one isocyanate-reactive function.

### Component A)

Suitable ketones for preparing the ketone resins and ketone-aldehyde resins (component A) include all ketones, especially acetone, acetophenone, methyl ethyl ketone, tert-butyl methyl ketone, heptan-2-one, pentan-3-one, methyl isobutyl ketone, cyclopentanone, cyclododecanone, mixtures of 2,2,4- and 2,4,4-trimethylcyclopentanone, cycloheptanone, and cyclooctanone, cyclohexanone and all alkyl-substituted cyclohexanones having one or more alkyl radicals containing a total of 1 to 8 carbon atoms, individually or in a mixture. Examples that may be given of alkyl-substituted cyclohexanones include 4-tert-amylcyclohexanone, 2-sec-butylcyclohexanone, 2-tert-butylcyclohexanone, 4-tert-butylcyclohexanone, 2-methyl-cyclohexanone, and 3,3,5-trimethylcyclohexanone.

Generally speaking, however, it is possible to use all of the ketones said to be suitable in the literature for ketone and ketone-aldehyde resin syntheses, more generally all C—H-acidic ketones. Preference is given to ketone-aldehyde resins based on the ketones acetophenone, cyclohexanone, 4-tert-butylcyclohexanone, 3,3,5-trimethylcyclohexanone, and heptanone, alone or in a mixture, and to ketone resins based on cyclohexanone.

As the aldehyde component of the ketone-aldehyde resins (component A) suitability is possessed in principle by unbranched or branched aldehydes, such as formaldehyde, acetaldehyde, n-butyraldehyde and/or isobutyraldehyde, valeraldehyde, and dodecanal. Generally speaking it is possible to use all of the aldehydes said to be suitable in the literature for ketone resin syntheses. Preference, however, is given to using formaldehyde, alone or in mixtures.

The required formaldehyde is typically used as an aqueous or alcoholic (e.g., methanol or butanol) solution with a strength of approximately from 20% to 40% by weight. Other use forms of formaldehyde, such as the use of para-formaldehyde or trioxane, are likewise possible. Aromatic aldehydes, such as benzaldehyde, may likewise be included in a mixture with formaldehyde.

Starting compounds used with particular preference for component A) are acetophenone, cyclohexanone, 4-tert-butylcyclohexanone, 3,3,5-trimethylcyclohexanone, and heptanone, alone or in a mixture, and formaldehyde.

Used likewise as component A) are hydrogenated derivatives of the resins from ketone and aldehyde. The above-described ketone-aldehyde resins are hydrogenated with hydrogen in the presence of a catalyst at pressures of up to 300 bar. Under these conditions the carbonyl group of the ketone-aldehyde resin is converted into a secondary hydroxyl group. Depending on the reaction conditions, some of the hydroxyl groups may be eliminated, resulting in methylene groups. This is illustrated by the following scheme:

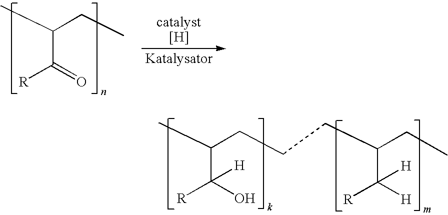

As component A) use is made, additionally, of urea-aldehyde resins using a urea of the general formula (I)

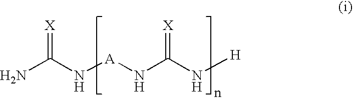

in which X is oxygen or sulfur, A is an alkylene radical, and n is 0 to 3, with 1.9 (n+1) to 2.2 (n+1) mol of an aldehyde of the general formula (ii)

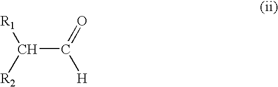

in which R₁ and R₂ are hydrocarbon radicals (e.g., alkyl, aryl and/or alkylaryl radicals) each having up to 20 carbon atoms and/or formaldehyde.

Suitable ureas of the general formula (I) with n=0 are for example urea and thiourea, with n=1 methylenediurea, ethylenediurea, tetramethylenediurea and/or hexamethylenediurea, and also mixtures thereof. Preference is given to urea.

Suitable aldehydes of the general formula (II) are for example isobutyraldehyde, 2-methylpentanal, 2-ethylhexanal, and 2-phenylpropanal, and also mixtures thereof. Preference is given to isobutyraldehyde.

Formaldehyde can be used in aqueous form, which in part or in whole may also include alcohols—methanol or ethanol, for example—or else as para-formaldehyde and/or trioxane.

Generally speaking, all monomers described in the literature for the preparation of aldehyde-urea resins are suitable.

Typical preparation procedures and compositions are described for example in DE 27 57 220, DE-A 27 57 176, and EP 0 271 776.

### Component B)

Suitability as component B) is possessed by aromatic, aliphatic and/or cycloaliphatic diisocyanates and/or polyisocyanates.

Examples of diisocyanates and polyisocyanates are cyclohexane diisocyanate, methylcyclohexane diisocyanate, ethylcyclohexane diisocyanate, phenylene diisocyanate, propylcyclohexane diisocyanate, methyldiethylcyclohexane diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyloctane 1,8-diisocyanate (TIN), decane diisocyanate and triisocyanate, undecane diisocyanate and triisocyanate, dodecane diisocyanates and triisocyanates, isophorone diisocyanate (IPDI), bis(isocyanatomethylcyclohexyl)methane (H₁₂MDI), isocyanatomethylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆-XDI) or 1,4-bis(isocyanatomethyl)cyclohexane (1,4-H₆-XDI), alone or in a mixture.

Another preferred class of polyisocyanates as component B) are the compounds prepared by dimerizing, trimerizing, allophanatizing, biuretizing and/or urethanizing the simple diisocyanates and having more than two isocyanate groups per molecule, examples being the reaction products of these simple diisocyanates, such as IPDI, TMDI, HDI and/or H₁₂MDI, with polyhydric alcohols (e.g., glycerol, trimethylolpropane, pentaerythritol) or with polyfunctional polyamines, or the triisocyanurates obtainable by trimerizing the simple diisocyanates, such as IPDI, HDI and H₁₂MDI, for example.

The specific polyethers (component C)) can be introduced by reacting a (poly)isocyanate and/or mixtures of different (poly)isocyanates with component C), which has at least one isocyanate-reactive function, such as OH or NH, in such a way that at least one NCO function is retained, followed by reaction with A).

The introduction of component C) may alternatively be accomplished in situ during the preparation of the preadduct.

### Component C)

The polyalkylene oxides C) used with preference in the invention are described for example in EP 1078 946. They possess the general formula (a):

R¹O(SO)ₐ(EO)_{b}(PO)_{c}(BO)_{d}R², (a)

where R¹ is a straight-chain or branched or cycloaliphatic radical having 1 to 13 carbon atoms, R²=hydrogen, an aryl radical, alkyl radical or carboxylic radical having in each case 1 to 8 carbon atoms,
SO=styrene oxide,
EO=ethylene oxide,
PO=propylene oxide,
BO=butylene oxide and
a=0 to 10,
b=1 to 50,
c=0 to 3,
d=0 to 3,
with b>=a+c+d.

In accordance with the invention it is also possible as component C) to use a mixture of at least two different polyalkylene oxides.

The reaction of A) with B) and C) can take place in one or two stages, in the latter case first reacting component B) with C) such that at least one free isocyanate group is retained and can then be further reacted with component A).

The reaction may take place in bulk (without solvent) or in the presence of a suitable solvent. Preferred solids contents when using solvent are from 40% to 95% by mass, more preferably from 50% to 80% by mass.

Suitable solvents are those which are inert toward isocyanates. Preference is given, for example, to acetates, ketones, ethers, including glycol ethers, aliphatics, aromatics and ionic liquids without isocyanate-reactive groups, alone in a mixture. Ionic liquids for the purposes of the present invention are salts having a melting point of not more than 100° C. An overview of ILs is given by, for example, Welton (Chem. Rev. 99 (1999), 2071) and Wasserscheid et al. (Angew. Chem. 112 (2000), 3926).

It is also possible to use what are known as reactive diluents, which are typically used in radiation-curable varnishes and paints.

Solvents useful with preference as reactive diluents are acrylic acid and/or methacrylic acid, C₁-C₄₀ alkyl esters and/or cycloalkyl esters of methacrylic acid and/or acrylic acid, glycidyl methacrylate, glycidyl acrylate, 1,2-epoxybutyl acrylate, 1,2-epoxybutyl methacrylate, 2,3-epoxycyclopentyl acrylate, 2,3-epoxycyclopentyl methacrylate, and the analogous amides, the presence of styrene and/or its derivatives being a further possibility.

Another preferred class of radiation-reactive solvents as reactive diluents are di-, tri- and/or tetraacrylates and their methacrylic analogues, which result formally from the reaction products of acrylic or methacrylic acid and an alcohol component with elimination of water. Customary alcohol components for this purpose include, for example, ethylene glycol, 1,2- and 1,3-propanediol, diethylene glycol, dipropylene and tripropylene glycol, triethylene glycol and tetraethylene glycol, 1,2- and 1,4-butanediol, 1,3-butylethylpropanediol, 1,3-methylpropanediol, 1,5-pentanediol, 1,4-bis(hydroxymethyl)cyclohexane (cyclohexane-dimethanol), glycerol, hexanediol, neopentyl glycol, trimethylolethane, trimethylolpropane, pentaerythritol, bisphenol A, B, C and F, norbornylene glycol, 1,4-benzyldimethanol, 1,4-benzyldiethanol, 2,4-dimethyl-2-ethylhexane-1,3-diol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, trimethylolpropane, 3(4),8(9)-bis(hydroxymethyl)tricyclo[5.2.1.0^{2.6}]decane (Dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl) isocyanurate, mannitol, sorbitol, polypropylene glycols, polybutylene glycols, xylylene glycol or neopentyl glycol hydroxypivalate, and also ethylene- or propylene-containing derivatives thereof, alone or in mixtures.

In a preferred embodiment 1) for example, one mole of a polyether (component C)) is reacted with one mole of diisocyanate (component B)), where appropriate with the use of a suitable solvent and a suitable catalyst, in such a way that one isocyanate group remains unreacted.

The product prepared is added to a solution or melt of the hydroxyl-containing ketone, ketone-aldehyde or urea-aldehyde resins or hydrogenated derivatives thereof (A) and the system is reacted.

It has proven advantageous to react 1 mol of component A)—based on Mₙ—with from 0.2 to 15 mol, particularly from 0.25 to 10 mol, of the reaction product of components B) and C).

The reaction temperature is selected in accordance with the reactivity of the components with one another. Temperatures which have been found appropriate for all reaction steps are those from 30 to 125° C., preferably from 50 to 100° C.

In a preferred embodiment 2) one mole (based on Mₙ) of a solution or melt of the hydroxyl-containing ketone, ketone-aldehyde or urea-aldehyde resins or hydrogenated derivatives thereof (A) is reacted with, for example, one mole of a polyether (component C)) and one mole of diisocyanate (component B)), where appropriate with the use of a suitable solvent and a suitable catalyst, until the NCO number is less than 0.2%.

It has proven advantageous to react 1 mol of component A)—based on Mₙ—with from 0.2 to 15 mol, particularly from 0.25 to 10 mol, of each of components B) and C).

The reaction temperature is selected in accordance with the reactivity of the components with one another. Temperatures which have been found appropriate for all reaction steps are those from 30 to 125° C., preferably from 50 to 100° C.

It is possible if desired to use a suitable catalyst for preparing the resins of the invention. Suitable compounds are all those known in the literature which accelerate an NH— or OH—NCO reaction, such as catalysts based on the metals tin, bismuth, zirconium, titanium, zinc, iron and/or aluminum, such as carboxylates, chelates, and complexes, and/or purely organic catalysts such as tertiary amines, for example 1,4-diazabicyclo[2.2.2]octane (DABCO), 1,8-diazabicyclo[5.4.0]undec-7-ene (DBU), N,N-dimethylcyclohexylamine (DMCA) or 1,5-diazabicyclo[2.3.0]non-5-ene (DBN).

The reaction product of A), B) and C) may contain further auxiliaries and additives selected from organic solvents, water, inhibitors, surface-active substances, oxygen scavengers and/or free-radical scavengers, catalysts, light stabilizers, color brighteners, photosensitizers, photoinitiators, additives for influencing rheological properties, such as thixotropic agents and/or thickeners, flow control agents, antiskinning agents, plasticizers, defoamers, antistats, lubricants, wetting agents, dispersants, further oligomers and/or polymers, such as polyesters, polyacrylates, polyethers, epoxy resins, preservatives such as fungicides and/or biocides, thermoplastic additives, dyes, pigments, matting agents, flame retardants, fillers and/or blowing agents.

The glass transition temperature (T_{g}) of the reaction products of A) and B) and C) is from −30 to 120° C., preferably from −10 to 10° C., more preferably from 0 to 80° C.

The molecular weight Mₙ of the products of the invention is from 500 to 30 000 g/mol, preferably from 750 to 10 000 g/mol, more preferably from 800 to 5000 g/mol.

The molecular weight M_{w} of the products of the invention is from 1000 to 80 000 g/mol, preferably from 1500 to 20 000 g/mol, more preferably from 1500 to 10 000 g/mol.

The Gardner color number (50% in ethyl acetate) of the products of the invention is from 0 to 10, preferably from 0 to 7, more preferably from 0 to 5.

The resins of the invention enjoy universal solubility and stability to hydrolysis, are possessed of low brittleness, and are suitable for use as a main, base or addition component in aqueous, solvent-containing, and solvent-free coating materials, ballpoint pen pastes, pigment pastes, inks, including printing inks, polishes, glazes, filling compounds, cosmetics articles, sealants and/or insulants, and adhesives, and also for coloring plastics, particularly for the purpose of enhancing the color properties and adhesion properties in conjunction with good gloss, good hardness, and scratch resistance.

### EXAMPLES

The examples below are intended to illustrate the invention but not to restrict the scope of its application:

### 1) Preparation of a Polyalkylene Oxide (Component C))

336.4 g (2.34 mol) of trimethylcyclohexanol and 16.3 g (0.23 mol) of potassium methoxide were charged to a reactor. After careful blanketing with pure nitrogen, this initial charge was heated to 110° C. and 308.2 g (2.554 mol) of styrene oxide were added over the course of an hour. After two further hours the addition reaction of the styrene oxide was at an end, as recognizable from a residual styrene oxide content of <0.1% by weight by gas chromatogram. Subsequently 339.2 g (7.71 mol) of ethylene oxide were metered into the reactor at a rate such that the internal temperature did not exceed 120° C. and the pressure did not exceed 6 bar. After all of the ethylene oxide had been introduced the temperature was held at 115° C. until a constant manometer pressure indicated the end of the subsequent reaction. Finally at 80 to 90° C. the unreacted, residual monomers were removed under reduced pressure. The product obtained was neutralized using phosphoric acid and the water was removed by distillation and the potassium phosphate formed by filtration together with a filter aid. The molecular weight from the determination of the hydroxyl number, with an assumed functionality of 1, was M=467 g/mol.

### 2) Preparation of a Ketone-Aldehyde Resin (Component A))

1200 g of acetophenone, 220 g of methanol, 0.3 g of benzyltributylammonium chloride, and 360 g of 30% strength aqueous formaldehyde solution are introduced into a vessel and homogenized with stirring. This is followed by the addition with stirring of 32 g of 25% strength aqueous sodium hydroxide solution. Thereafter, at 80 to 85° C. and with stirring, 655 g of 30% strength aqueous formaldehyde solution are added over 90 minutes. After 5 h of stirring at reflux temperature the stirrer is switched off and the aqueous phase is separated from the resin phase. The crude product is washed with very dilute acetic acid until a melt sample of the resin has a clear appearance. The resin is then dried by distillation.

This gives 1270 g of a slightly yellowish resin. The resin is clear and brittle and possesses a melting point of 72° C. It is soluble in, for example, acetates such as butyl acetate and ethyl acetate, and in aromatics such as toluene and xylene. It is insoluble in ethanol.

400 g of the resin thus prepared are dissolved in 650 g of tetrahydrofuran (water content approximately 7%). The resin is then hydrogenated at 260 bar and 160° C. in an autoclave (from Parr) with a catalyst basket containing 100 ml of a commercially customary Ru catalyst (3% Ru on alumina). After 20 h the reaction mixture is discharged from the reactor via a filter. Properties: hydroxyl number 314 mg KOH/g; melting point 116° C.; Gardner color number (50% in ethyl acetate) 0.2. The hydrogenated resin is soluble in ethanol, dichloromethane, ethyl acetate, butyl acetate, isopropanol, acetone, and diethyl ether. It is insoluble in nonpolar solvents such as n-hexane or white spirit.

### 3) Preparation of the Inventive Reaction Product

A solution of 935 g of the polyalkylene oxide of Example 1) and 0.2 g of dibutyltin dilaurate in 625 g of acetone is admixed rapidly, under nitrogen and with stirring, with 444 g of isophorone diisocyanate, at a rate such that the exothermic reaction remains readily manageable. Stirring is subsequently continued at 60° C. until the NCO number of the solution has fallen below 2.1% NCO (determined in accordance with DIN 53185).

After it has cooled to room temperature, the reaction product thus prepared is admixed under nitrogen with 725 g of the ketone/aldehyde resin from Example 2) in solution in 480 g of acetone, and also with 0.1 g of DBTL. The mixture is stirred at reflux temperature until an NCO content of below 0.1% (determined in accordance with DIN 53185) is reached. The reaction product is freed from the solvent. Mₙ=2200 g/mol; M_{w} 5600; Gardner color number (50% in ethyl acetate)=2.3. The product prepared is soluble in ethanol, ethyl acetate, butyl acetate, methoxypropyl acetate, xylene, and white spirit, and forms a stable dispersion in water.

### 4) Preparation of the Inventive Reaction Product

A solution of 1496 g of the Polyglykol M 750 (Clariant) and 0.3 g of dibutyltin dilaurate in 1293 g of acetone is admixed rapidly, under nitrogen and with stirring, with 444 g of isophorone diisocyanate, at a rate such that the exothermic reaction remains readily manageable. Stirring is subsequently continued at 60° C. until the NCO number of the solution has fallen below 2.4% NCO (determined in accordance with DIN 53185).

After it has cooled to room temperature, the reaction product thus prepared is admixed under nitrogen with 905 g of the ketone/aldehyde resin from Example 2) in solution in 605 g of acetone, and also with 0.2 g of DBTL. The mixture is stirred at reflux temperature until an NCO content of below 0.1% (determined in accordance with DIN 53185) is reached. The reaction product is freed from the solvent. Mₙ=3150 g/mol; M_{w} 7950; Gardner color number (50% in ethyl acetate)=2.1. The product prepared is soluble in ethanol, ethyl acetate, butyl acetate, methoxypropyl acetate, xylene, white spirit, and n-hexane, and forms a stable dispersion in water.

### 5) Production of Pigment Preparations

For this purpose the inventive products of Examples 3) and 4) were mixed with water and/or organic solvent, and then the pigments were added. Following the addition of 2 mm glass beads, the components were dispersed in a Dispermat at 3000 rpm and at 35° C. for 30 minutes. The aqueous pigment preparations were adjusted to a pH of approximately 9 using a mixture of dimethylaminoethanol and water (1:1% by weight).

### 5A) Formulation of an Aqueous Black Pigment Preparation (Inventive)

| | | |
|---|---|---|
| 71 | g | water |
| 8 | g | inventive products from Example 3) and 4) |
| 20 | g | Spezialschwarz 4 (carbon black; Degussa AG) |

These black pigment preparations were readily stirrable and foam-free.

### 5B) Formulation of an Aqueous Black Pigment Preparation (Comparative)

| | | |
|---|---|---|
| 71 | g | water |
| 8 | g | non-inventive compound from Example 1) |
| 20 | g | Spezialschwarz 4 (carbon black; Degussa AG) |

This black pigment preparation was of high viscosity and underwent severe foaming.

### 5C) Formation of a Solvent-Containing Black Pigment Preparation (Inventive)

| | |
|---|---|
| 80 g | butyl glycol |
| 25 g | inventive product from Example 3) and 4) |
| 20 g | Spezialschwarz 4 (carbon black; Degussa AG) |

These black pigment preparations were of relatively low viscosity.

6) Production of Coating Materials from the Pigment Preparations

To produce coating materials, the pigment preparations were introduced into a vessel and the letdown compounds were added in portions.

### 6A) Production of Solvent-Free Black Coating Materials

The inventive pigment preparations (Example 5A with the products from Example 3) and 4)) and the non-inventive pigment preparation (Example 5B) were let down with an aqueous polyurethane dispersion.

| | inventive | | inventive | | comparative | |
|---|---|---|---|---|---|---|
| Black pigment | 8.4 g from | | 8.4 g from | | 8.4 g from | |
| preparation | Example 5A) | | Example 5A) | | Example 5B) | |
| | product of Ex. 3) | | product of Ex. 4) | | | |
| Alberdingk U 800 | 63.0 | g | 63.0 | g | 63.0 | g |
| (Alberdingk Boley | | | | | | |
| GmbH) | | | | | | |

Drying: 1 h at 60° C., drawdown onto glass
plate & Bonder using 100 μm drawing frame

| Gloss 20° | 76 | | 77 | | 74 | |
|---|---|---|---|---|---|---|
| Gloss 60° | 89 | | 88 | | 84 | |
| Haze gloss | 16-24 | | 24 | | 18 | |
| Pendulum | 97 | | 95 | | 87 | |
| hardness | | | | | | |
| Erichsen cupping | 7.5 | mm | 8.1 | mm | 7.1 | mm |

### 5B) Production of Solvent-Containing and Low-Solvent Black Coating Materials

The inventive solvent-containing black pigment preparations (Example 5C) with the products from Example 3) and 4) were let down in both solvent-containing and aqueous form.

| | Black pigment preparation | |
|---|---|---|
| | 6.8 g from | 7.0 g from |
| | Example 5C) | Example 5C) |
| | product of Ex. 3) | product of Ex. 3) |
| Degalan 706 (Röhm GmbH) | 50.0 g | 63.0 g |
| Dynapol HW 112-56 | — | 55.5 g |
| (Degussa AG) | | |
| Cymel 325 (Cytec) | — | 3.7 g |
| Demineralized water | — | 10.0 g |
| Tego 7447, 10% in water | — | 0.8 g |
| (Tego Chemie Service | | |
| GmbH) | | |
| Drawdown onto glass | Drying: 24 h at | Drying: 20 min at |
| plate using 100 μm | 25° C. | 140° C. |
| drawing frame | | |
| Gloss 20° | 77 | 95 |
| Gloss 60° | 89 | 98 |
| Haze gloss | 21-27 | 63-69 |
| Pendulum hardness | 151 | 189 |

| | Black pigment preparation | | |
|---|---|---|---|
| | 6.8 g from | 7.0 g from | |
| | Example 5C) | Example 5C) | |
| | product of Ex. 4) | product of Ex. 4) | |
| Degalan 706 (Röhm GmbH) | 50.0 g | 63.0 | g |
| Dynapol HW 112-56 | — | 55.5 | g |
| (Degussa AG) | | | |
| Cymel 325 (Cytech) | — | 3.7 | g |
| Demineralized water | — | 10.0 | g |
| Tego 7447, 10% in water | — | 0. | g |
| (Tego Chemie Service | | | |
| GmbH) | | | |

| | | |
|---|---|---|
| Drawdown onto glass | Drying: 24 h at | Drying: 20 min at |
| plate using 100 μm | 25° C. | 140° C. |
| drawing frame | | |
| Gloss 20° | 75 | 94 |
| Gloss 60° | 87 | 98 |
| Haze gloss | 24 | 67-75 |
| Pendulum hardness | 147 | 177 |

With the products of the invention it is possible to produce aqueous, solvent-containing, and solvent-free pigment preparations and coating materials. In contrast to the comparative examples, the aqueous pigment preparations are of relatively low viscosity and are virtually foam-free. In spite of their high hardness the films produced using the products of the invention are possessed of a low brittleness.

1. A resin obtainable obtained by sole reaction or proportional reaction of
A) hydroxyl-containing ketone resin, ketone/aldehyde resin and/or urea/aldehyde resin and/or a hydrogenated derivative thereof;
B) at least one aromatic, aliphatic and/or cycloaliphatic diisocyanate or polyisocyanate; and
C) at least one specific polyether having at least one isocyanate-reactive function.

2. The resin according to claim 1, wherein
a C—H-acidic ketone is used in the ketone-aldehyde resin of component A).

3. The resin according to claim 1, wherein at least one ketone selected from the group consisting of acetone, acetophenone, methyl ethyl ketone, heptan-2-one, pentan-3-one, methyl isobutyl ketone, cyclopentanone, cyclododecanone, mixtures of 2,2,4- and 2,4,4-trimethylcyclopentanone, cycloheptanone, cyclooctanone and cyclohexanone is used as starting compound in the ketone-aldehyde resin of component A).

4. The resin according to claim 1, wherein at least one alkyl-substituted cyclohexanone having one or more alkyl radicals containing a total of 1 to 8 carbon atoms is used in the ketone-aldehyde resins of component A).

5. The resin according to claim 1, wherein 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone are used in the ketone-aldehyde resin of component A).

6. The resin according to claim 1, wherein at least one of acetophenone, cyclohexanone, 4-tert-butylcyclohexanone, 3,3,5-trimethylcyclohexanone, and heptanone, alone or in a mixture, are used in component A).

7. The resin according to claim 1, wherein at least one of formaldehyde, acetaldehyde, n-butyraldehyde and/or isobutyraldehyde, valeraldehyde, and dodecanal are used as aldehyde component of the ketone-aldehyde resin in component A).

8. The resin according to claim 1, wherein formaldehyde and/or para-formaldehyde and/or trioxane are used as aldehyde component of the ketone-aldehyde resin in component A).

9. The resin according to claim 1, wherein a resin comprising formaldehyde and at least one of acetophenone, cyclohexanone, 4-tert-butylcyclohexanone, 3,3,5-trimethylcyclohexanone and heptanone, is used in component A).

10. The resin according to claim 1, wherein the resin of any one of the following, which has been hydrogenated following its preparations is used as component A):
a C—H-acidic ketone;
at least one ketone selected from the group consisting of acetone, acetophenone, methyl ethyl ketone, heptan-2-one, pentan-3-one, methyl isobutyl ketone, cyclopentanone, cyclododecanone, mixtures of 2,2,4- and 2,4,4-trimethylcyclopentanone, cycloheptanone, cyclooctanone and cyclohexanone;
at least one alkyl-substituted cyclohexanone having one or more alkyl radicals containing a total of 1 to 8 carbon atoms;
4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone;
at least one of acetophenone, cyclohexanone, 4-tert-butylcyclohexanone, 3,3,5-trimethylcyclohexanone, and heptanone;
at least one of formaldehyde, acetaldehyde, n-butyraldehyde and/or isobutyraldehyde, valeraldehyde, and dodecanal;
formaldehyde and/or para-formaldehyde and/or trioxane; and
a resin comprising formaldehyde and at least one of acetophenone, cyclohexanone, 4-tert-butylcyclohexanone, 3,3,5-trimethylcyclohexanone and heptanone.

11. The resin according to claim 10, wherein the hydrogenated derivative of the resin comprising formaldehyde and at least one of acetophenone, cyclohexanone, 4-tert-butylcyclohexanone, 3,3,5-trimethylcyclohexanone and heptanone, is used as component A).

12. The resin according to claim 1, wherein urea-aldehyde resin prepared using a urea of the general formula (i) 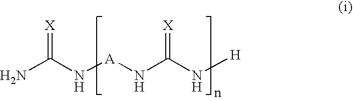
in which X is oxygen or sulfur, A is an alkylene radical, and n is 0 to 3, with 1.9 (n+1) to 2.2 (n+1) mol of an aldehyde of the general formula (ii) 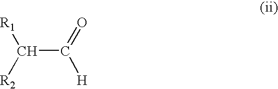
in which R₁ and R₂ are hydrocarbon radicals each having up to 20 carbon atoms and/or formaldehyde, is used as component A).

13. The resin according to claim 1, wherein urea-aldehyde resin prepared using urea and thiourea, methylenediurea, ethylenediurea, tetramethylenediurea and/or hexamethylenediurea or a mixture thereof is used as component A).

14. The resin according to claim 1, wherein urea-aldehyde resin prepared using isobutyraldehyde, formaldehyde, 2-methylpentanal, 2-ethylhexanal and, 2-phenylpropanal or a mixture thereof is used as component A).

15. The resin according to claim 1, wherein urea-aldehyde resin prepared using urea, isobutyraldehyde, and formaldehyde is used as component A).

16. The resin according to claim 1, wherein diisocyanates and polyisocyanates are used as component B), selected from cyclohexane diisocyanate, methylcyclohexane diisocyanate, ethylcyclohexane diisocyanate, phenylene diisocyanate, propylcyclohexane diisocyanate, methyldiethylcyclohexane diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyloctane 1,8-diisocyanate (TIN), decane diisocyanate and triisocyanate, undecane diisocyanate and triisocyanate, dodecane diisocyanates and triisocyanates, isophorone diisocyanate (IPDI), bis(isocyanatomethylcyclohexyl)methane (H₁₂MDI), isocyanatomethylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆-XDI) or 1,4-bis(isocyanatomethyl)cyclohexane (1,4-H₆-XDI), alone or in a mixture.

17. The resin according to claim 1, wherein polyisocyanate prepared by dimerizing, trimerizing, allophanatizing, biuretizing and/or urethanizing simple diisocyanate is used as component B).

18. The resin according to claim 1, wherein isocyanate based on IPDI, TMDI, H₁₂MDI and/or HDI is used as component B).

19. The resin according to claim 1, wherein polyalkylene oxide of the general formula (a):
R¹O(SO)ₐ(EO)_{b}(PO)_{c}(BO)_{d}R², (a)
where R¹ is a straight-chain or branched or cycloaliphatic radical having 1 to 13 carbon atoms,
R²=hydrogen, an aryl radical, alkyl radical or carboxylic radical having in each case 1 to 8 carbon atoms,
SO=styrene oxide,
EO=ethylene oxide,
PO=propylene oxide,
BO=butylene oxide and
a=0 to 10,
b=1 to 50,
c=0 to 3,
d=0 to 3,
with b>=a+c+d, is used as component C).

20. The resin according to claim 19, wherein a mixture of at least two different polyalkylene oxides is used as component C).

21. The resin according to claim 1, characterized in that wherein the reaction product of A), B) and C) contains 1 mol of component A)—based on Mₙ—and also from 0.2 to 15 mol of components B) and C).

22. The resin according to claim 1, wherein the resin further comprises auxiliaries and additives.

23. The resin according to claim 1, wherein the resin further comprises auxiliaries and additives selected from organic solvents, water, inhibitors, surface-active substances, oxygen scavengers and/or free-radical scavengers, catalysts, light stabilizers, color brighteners, photosensitizers, photoinitiators, additives for influencing rheological properties, such as thixotropic agents and/or thickeners, flow control agents, antiskinning agents, plasticizers, defoamers, antistats, lubricants, wetting agents, dispersants, further oligomers and/or polymers, such as polyesters, polyacrylates, polyethers, epoxy resins, preservatives such as fungicides and/or biocides, thermoplastic additives, dyes, pigments, matting agents, flame retardants, fillers and/or blowing agents.

24. The resin according to claim 1, wherein
the glass transition temperature (T_{g}) of the reaction product of A) and B) and C) is from −30 to 120° C.;
the molecular weight Mₙ of the product is from 500 to 30 000 g/mol;
the molecular weight Mₙ of the product is from 1000 to 80 000 g/mol; and
the Gardner color number (50% in ethyl acetate) of the product is from 0 to 10.

25. The resin according to claim 1, wherein
the reaction of A) with B) and C) takes place in bulk.

26. The resin according to claim 1, wherein
the reaction of A) with B) and C) takes place in the presence of a solvent.

27. The resin according to claim 26, wherein
the solvent used is inert toward isocyanates.

28. The resin according to claim 26, wherein
the solvent used is selected from acetates, ketones, ethers, including glycol ethers, aliphatics, aromatics, reactive diluents for radiation-curable coating materials, and ionic liquids without isocyanate-reactive groups, alone or in a mixture.

29. A process for preparing a resin by sole reaction or proportional reaction of
A) hydroxyl-containing ketone resin, ketone/aldehyde resin and/or urea/aldehyde resin and/or a hydrogenated derivative thereof;
B) at least one aromatic, aliphatic and/or cycloaliphatic diisocyanate or polyisocyanate; and
C) at least one specific polyether having at least one isocyanate-reactive function,
comprising reacting A) with B) and C) in one or two stages, in the latter case first reacting component B) with C) such that at least one free isocyanate group is retained and can then be further reacted with component A), at a temperature of from 30 to 125° C.

30. The process for preparing a resin according to claim 29, wherein a suitable catalyst can be used.

31. The process for preparing a resin according to claim 29, wherein catalysts based on the metals tin, bismuth, zirconium, titanium, zinc, iron and/or aluminum, and/or purely organic catalysts are used.

32-33. (canceled)

34. An article produced and/or coated with a coating composition comprising the resin according to claim 1.
